(19) United States
(12) Patent Application Publication
(10) Pub. No.: US 2012/0261383 A1
(43) Pub. Date: Oct. 18, 2012

(54) CIRCUIT BREAKER ARRANGEMENT

(75) Inventors: Shibani Bose, Berlin (DE); Lutz-Rüdiger Jänicke, Mahlow (DE)

(73) Assignee: SIEMENS AKTIENGESELLSCHAFT, MUENCHEN (DE)

(21) Appl. No.: 13/513,738

(22) PCT Filed: Nov. 18, 2010
(86) PCT No.: PCT/EP10/67739

§ 371 Date: Jun. 22, 2012

(30) Foreign Application Priority Data
Dec. 4, 2009 (DE) 10 2009 057 703.3

(51) Int. Cl. H01H 33/70

(52) U.S. Cl. 218/52

(57) ABSTRACT

A circuit breaker arrangement has a switch route. An exhaust channel leads from a contact gap for removing switching gas that arises in the contact gap. A coolant blow-in opening opens into the exhaust channel. The coolant blow-in opening is associated with a compression device.

The invention relates to a circuit breaker arrangement with a switching path and an exhaust channel continuing from the switching path for switching gas arising in the switching path.

Such a circuit breaker arrangement is known, for example, from the German patent specification DE 197 02 822 B1. Said document describes a circuit breaker arrangement which has a heating space for intermediately storing switching gas. A compression space which compresses quenching gas over the course of a breaking movement by a driven compression piston within a compression cylinder of the compression space, is arranged downstream of the heating space. As soon as the quenching gas pressure in the compression space is greater than the pressure in the upstream heating space, quenching gas flows into the heating space via a valve. From said heating space, the previously compressed quenching gas passes into a switching path and blows an arc which may be burning there.

In the known circuit breaker arrangements, direct blowing of the arc is envisaged in order to cool said arc and in order to prevent the arc from restriking once the arc has been quenched.

The switching path generally represents one of the regions which is subjected to the greatest thermal load within a circuit breaker arrangement. Owing to the arc, switching gas is heated and a plasma is produced. In addition, hard gas is possibly produced by combustion of insulating materials. Owing to the overheating and pressure increase resulting in the switching path, correspondingly intense blowing-in of a quenching medium is required. In order to produce an effective flow of the quenching medium, the compression cylinder of the known compression space needs to be dimensioned so as to have a sufficiently large volume. A correspondingly large-volume design results in an increase in the required drive energy for the compression piston. An increased drive energy can be provided by an enlarged drive device. Any enlargement of a drive device results in inefficient circuit breaker arrangements.

Therefore, the object of the invention is to develop a circuit breaker arrangement such that, despite an increase in the switching power, the required drive energy only increases to a limited extent.

According to the invention, this is achieved with a circuit breaker arrangement of the type mentioned at the outset in that a cooling media blow-in opening opens out into the exhaust channel.

For example, a switching path is formed between switching contact pieces which are movable relative to one another. In order to produce an electrical current path, the switching contact pieces are brought into DC-contact with one another. In order to interrupt an electrical current path, the switching contact pieces are isolated from one another, with the result that an isolating gap is formed between them. Circuit breaker arrangements are dimensioned such that currents occurring in the respective current path can be managed, i.e. even disconnected, by the circuit breaker arrangement. Thus, circuit breaker arrangements can switch nominal currents, for example, i.e. currents which correspond to the rated current of the current path to be switched. However, circuit breaker arrangements are also capable of interrupting short-circuit currents reliably. Short-circuit currents are a multiple of a nominal current of the current path. In the event of a switching operation of a circuit breaker arrangement, this may result in an arc being produced, depending on the time of DC isolation of the switching contact pieces. In this case, a driving voltage is so great that, even once DC isolation of the switching contact pieces with respect to one another has taken place, a current will be driven through a for example fluid medium located in the switching path. An electrical current in the form of an arc is guided within the fluid medium. In order to direct and stem such an arc, said arc is preferably subjected at least temporarily to a fluid flow.

In interrupter units of circuit breaker arrangements, the use of electrically insulating liquids such as oils or of electrically insulating gases such as sulfur hexafluoride, nitrogen or other electrically insulating gases and gas mixtures have proven effective as fluid media. The fluid medium is arranged in and around the switching path and, in the case of known circuit breaker arrangements, is additionally blown if possible directly into the switching path in order to cool the arc. The energy required for the blowing-in process is insignificant in consideration of the energy inherent to the arc. In addition to the energy for moving the switching contact pieces which are movable relative to one another, the energy for subjecting the arc to a fluid flow also needs to be applied during a switching operation.

A fluid medium influenced by an arc such as, for example, a gas located in the switching path, a gas generated there or else a generated plasma etc. needs to be removed from the switching path in order to enable a “fresh” medium with a higher dielectric strength to then flow. The volume to be dissipated is denoted, as a generic term, as a switching gas irrespective of its composition and state, whether it be liquid or gaseous or plasmatic etc. Switching gas produced in the switching path passes via an exhaust channel at least partially into other regions of the circuit breaker arrangement remote from the switching path. The switching gas is removed from the switching path via the exhaust channel.

If a cooling media blow-in opening is now provided in the exhaust channel, it is possible to subject the exhaust channel additionally to a specific flow. In this case, the flow should be directed such that the switching gas is additionally accelerated in the direction in which it is flowing away or the process of it flowing away is assisted. It is thus possible, for example, to produce a negative pressure in the exhaust channel given a corresponding spacing between the cooling media blow-in opening and an outlet opening of the exhaust channel located in the vicinity of the switching path, with the result that the switching gas located in the switching path is sucked and is guided out of the switching path more quickly. A suitable cooling medium is the electrically insulating medium which flows through and around the interrupter unit. If the switching path is insulated by a gas, the cooling medium should also be a gas. If a liquid is located in the switching path, the cooling medium should also be liquid. The cooling medium should advantageously have an electrically insulating effect, with the result that, in addition to an acceleration of the flow in the exhaust channel, the dielectric strength of the switching gas is increased by cooling as the cooling medium blown into the exhaust channel mixes with the switching gas.

Advantageously, provision can be made for a compression device to be connected to the cooling media blow-in opening.

A compression device is capable of keeping certain cooling media quantities compressed at certain times or producing such quantities or, if necessary, releasing such quantities and introducing them into the exhaust channel via the cooling media blow-in opening. Compression increases the pressure of the cooling medium. Compression also results in the amount of space required for holding a certain quantity of cooling medium being limited. In this case, the compression device can act in a variety of ways. It is thus possible, for example, to use a compression device acting in accordance with mechanical operating principles, i.e. the compression device functions in the manner of a mechanical pump. In this case, the compression device can bring about a continuous increase in pressure, for example by virtue of a continuous compressor operation. However, provision can also be made for the compression device to provide a certain quantity of compressed cooling medium merely temporarily during a breaking operation or a making operation.

Provision can further be made for a thermodynamic compression device to be used, i.e. on the basis of a change in temperature and associated change in volume of the cooling medium, an increase in pressure of the cooling medium can take place in a closed space. When using a thermodynamic compression device, care needs to be taken to ensure that the temperature of the cooling medium is not exceeded in order to be able to exert a sufficient cooling effect of the cooling medium on the generally overheated switching gas.

Advantageously, provision can further be made for the switching path to be arranged in a switching vessel and for the exhaust channel to open out outside the switching vessel.

As described at the outset, a circuit breaker arrangement is used to switch currents, i.e. a current path is interrupted/produced by the circuit breaker arrangement. Depending on requirements, in this case the circuit breaker arrangements can have different forms. In general, the use of polyphase electrical energy transmission systems is envisaged in the industrial sector. In this case, a plurality of interrupter units belong to a circuit breaker arrangement, with the interrupter units each serving to interrupt a specific associated current path of the polyphase electrical energy transmission system. In this case, the interrupter units of the plurality of current paths are generally of identical design and a switching operation of the individual phases takes place simultaneously or at least temporally matched to one another in the plurality of phases of the electrical energy transmission system. Each interrupter unit in this case has a corresponding switching path, which takes on the function of DC isolation, i.e. electrical potential isolation of the respective switching contact pieces. For this purpose, the switching path of an interrupter unit is typically arranged within a switching vessel.

The switching vessel of an interrupter unit is aligned, for example, along a main axis and is designed so as to be substantially rotationally symmetrical with respect thereto. The end sides of the switching vessel can be delimited, for example, by electrically conductive sleeves, which can also be used for making electrical contact with the interrupter unit. Thus, the sleeves can be configured so as to be substantially tubular, with a contact-making device being provided on a lateral surface, it being possible for contact to be made with a conductor connection of a feed line via said contact-making device in order to loop in an interrupter unit and therefore the circuit breaker arrangement into a current path of an electrical energy transmission system. The two sleeves arranged at the ends therefore also serve to guide and conduct an electrical current to the switching contact pieces located in the interior. As such, at least in the break position of the circuit breaker arrangement, the two end-side sleeves should be arranged so as to be electrically insulated from one another. In order to be able to treat the interrupter unit as a structural unit, the sleeves are connected to one another at a rigid angle via an insulating link. This insulating link can be configured in the form of a tube, for example, with the result that a switching vessel, which is approximately closed on the lateral surface side, of the interrupter unit is provided along the main axis. However, provision can also be made for individual rods or the like to be used as insulating link, with the result that an open switching vessel is formed. The switching path should also preferably be arranged in the region of the insulating link. The switching path can be arranged, for example, coaxial to the main axis which is defined in terms of its alignment by the sleeves arranged at opposite ends of the main axis.

In particular in the case of a closed switching vessel, it is advantageous to discharge the switching gas to a location outside the switching vessel. For this purpose, the exhaust channel can open out in the interior of the switching vessel in the region of the switching path. With is other end, the exhaust channel advantageously opens out outside the switching vessel. The exhaust channel is guided to such an extent that it opens out at least in an envelope delimiting the switching vessel. It is thus possible, for example, for an opening to be provided on the lateral surface side or end side in a sleeve, said opening representing the outlet opening of the exhaust channel. The switching gas can flow away into the surrounding environment of the switching vessel via this outlet opening.

A further advantageous configuration can provide for the switching vessel to be surrounded by a fluid-tight encapsulating housing.

A fluid-tight encapsulating housing makes it possible to make access to the switching vessel (or the interrupter unit) which is arranged in the interior of the encapsulating housing more difficult. In this case, provision can be made for the interrupter unit(s) of a single phase of a polyphase electrical energy transmission system to be arranged in an encapsulating housing (single-phase insulation). However, provision can also be made for a plurality of or all of the interrupter units of a circuit breaker arrangement for switching a plurality of phases of a polyphase electrical energy transmission system to be located in a common encapsulating housing (polyphase insulation). The interior of the fluid-tight encapsulating housing can be filled with an electrically insulating fluid, for example. Owing to the fluid-tight configuration of the encapsulating housing, undesired evaporation of the fluid is made more difficult. Advantageously, virtually 100% sealing of the encapsulating housing is desired. Suitable fluids are electrically insulating gases or electrically insulating liquids which fill the interior of the encapsulating housing. Owing to an excess pressure in comparison with the surrounding environment of the encapsulating housing, an additional increase in the dielectric strength of the fluid is made possible. In particular in the case of gases, an increase in the dielectric strength of the gas in comparison with atmospheric conditions can thus be brought about.

An advantageous configuration can further provide for the compression device to at least partially delimit the exhaust channel.

If the exhaust channel is at least partially delimited by the compression device itself, a compact configuration of the entire circuit breaker arrangement is made possible. It is thus possible, by virtue of a corresponding surface configuration of the individual assemblies of the compression device, for the extent and position of the exhaust channel itself to be determined and influenced. It is thus possible, for example, to configure the compression device so as to be rotationally symmetrical in the basic shape of a cylinder, with the exhaust channel running along an outer lateral surface of the compression device. It is thus possible to provide the exhaust channel, at least sectionally, with a cross section in the form of a circular ring via the compression device. This also provides the possibility of blowing cooling medium flowing out of the cooling media blow-in opening into the exhaust channel with as little turbulence as possible, i.e. with as little friction as possible.

A further advantageous configuration can provide for the circuit breaker arrangement to have a switching gas intermediate storage volume, which extends, with respect to a main axis, on a first side of the switching path, and the exhaust channel extends on a second side of the switching path with is opposite the first side.

A switching gas intermediate storage volume is used for intermediate storage of switching gas. Switching gas generated in the switching path is introduced into the switching gas intermediate storage volume and intermediately stored there for a certain time period. Once the time period has elapsed, the intermediately stored switching gas flows out of the switching gas intermediate storage volume back into the switching path and is used for subjecting said switching path to a flow. Thermal energy generated by an arc is used to increase the pressure of the switching gas in the switching gas intermediate storage volume and to subject the switching path to a flow when it is fed back. The switching gas intermediate storage volume can also act in combination with an additional compression volume, which additionally supports a return flow of switching gas from the switching gas intermediate storage volume into the switching path. Both the fluid flow generated by the switching gas intermediate storage volume and the fluid flow generated by the additional compression volume are introduced into the switching path and run through the switching path in order then to be guided on at least partially from the switching path via the exhaust channel. By virtue of an arrangement of the exhaust channel and the switching gas intermediate storage volume on opposite sides of the switching path with respect to the main axis, a substantially elongated rotationally symmetrical configuration of a switching vessel, preferably in the manner of a cylinder with rounded end sides, is made possible. Such an elongated form makes it possible to construct slim circuit breaker arrangements which moreover also have an outer configuration of the switching vessel which is favorable in dielectric terms. The main axis is defined by the position of the end-side sleeves and the insulating link located between the sleeves. Therefore, the main axis extends along the sequence comprising end-side sleeve, insulating link and the adjoining end-side sleeve.

A further advantageous configuration can provide for the switching path to be surrounded by an insulating nozzle, which is movable relative to a switching contact piece.

By virtue of the use of an insulating nozzle in the switching path, it is possible to delimit an extension of a burning arc, i.e. the arc is guided within an insulating nozzle channel of the insulating nozzle and burns in the interior of the insulating nozzle. Thus, it is made more difficult for the arc to escape or flash over to other assemblies of the circuit breaker arrangement in an undesirable manner. The insulating nozzle also delimits the space in which the arc burns, with the result that blowing of the switching path needs to take place with a reduced volume of cooling media or intermediately stored switching gas. Therefore, the location of the hot arc within the switching vessel is concentrated in the region of the switching path and the arc is preferably guided substantially along a main axis. The insulating nozzle makes it more difficult for the arc to bulge or break out. A movement of the insulating nozzle relative to a switching contact piece makes it possible to control blocking of the insulating nozzle channel. It is thus possible, for example, to block the insulating nozzle channel at least temporarily by means of a switching contact piece, for example, with the result that a pressure increase by a burning arc within the insulating nozzle or in adjoining regions, for example the switching gas intermediate storage volume, can take place in a targeted manner. Thus, the insulating nozzle channel is opened or blocked by means of a valve device. In this case, the blocking can take place in such a way that the insulating nozzle channel is closed virtually 100%. However, provision can also be made for only partial blocking to take place, with the result that, for example, switching gas can flow out of the partially blocked end of the insulating nozzle channel. The insulating nozzle channel should in this case be shaped in such a way that fluids emerge from said insulating nozzle channel, if possible in the direction of an outlet of the exhaust channel, with the result that it is possible for there to be a transition which is as short as possible of switching gas from the insulating nozzle into the exhaust channel. Preferably, a switching contact piece can protrude at least temporarily into the insulating nozzle channel. In this case, the switching contact piece can also serve to at least temporarily and at least partially block the insulating nozzle channel.

A further advantageous configuration can provide for the compression device to be a mechanical compression device, which is driven via the insulating nozzle.

By virtue of a relative movement of the insulating nozzle within the switching vessel, it is possible to tap off kinematic energy at the insulating nozzle and introduce this energy into the compression device. The relative movement of the insulating nozzle with respect to the switching vessel makes it possible to operate the compression device. In this case, the insulating nozzle executes a certain stroke during a switching movement, with this stroke defining the manner of operation of the compression device or the volume of the cooling medium to be compressed. It is thus possible, for example, to drive a pump which compresses the insulating medium by virtue of a movement of the insulating nozzle or a piston coupled to the insulating nozzle or the like. Therefore, a separate drive device for a compression device associated with the interrupter unit is avoided. Therefore, the interrupter unit can be kept within its dimensions. Furthermore, movements of the individual movable component parts of the interrupter unit can be synchronized via such a coupling.

Generally, a drive device is used to generate a relative movement of the insulating nozzle or a relative movement of the switching contact pieces which delimit the switching path and are movable relative to one another, said drive device transferring its movement, for example via a rod of another mechanism, into the switching vessel. By virtue of a separation of the interrupter unit from the drive device and transfer of a movement via a corresponding gear mechanism, the drive device can be connected, for example, to a different electrical potential than the switching vessel or parts of the switching vessel. Furthermore, a physical spacing between the switching vessel and the drive device can be provided via the gear mechanism, with the result that, for example in spatially restricted installation positions, the drive device can be arranged so as to be removed from the switching vessel.

A further advantageous configuration can provide for the compression device to be aligned coaxially to the main axis.

A coaxial alignment of a compression device to the main axis makes it possible to maintain a substantially rotationally symmetrical design of the interrupter unit and to extend the interrupter unit only in the axial direction of the main axis. The compression device can now be inserted into the extended section. This compression device can have, for example, a compression cylinder and a compression piston which is movable relative to the compression cylinder, a relative movement between the compression piston and the compression cylinder preferably taking place in the direction of the main axis. In particular when using the compression device for fixing the extent of the exhaust channel, a flow-favorable cross section is thus provided, as a result of which the exhaust channel can be formed as a section in the form of an annular gap, for example, in the region of the compression device.

A further configuration can provide for a baffle plate to be arranged over the extent of the exhaust channel for deflecting the switching gas, with the switching gas being blasted against said baffle plate, and the cooling medium likewise being blasted against the baffle plate, the flows of switching gas and cooling medium being blasted against the baffle plate from opposite directions.

A baffle plate serves to deflect switching gas. A baffle plate can be provided with a flow-favorable contour, for example, for this purpose. Such a baffle plate should preferably have a pot-shaped structure, with the deflecting faces each being ruptured so as to reduce friction losses. The baffle plate can therefore have the configuration of an inner lateral surface of a hollow toroid or a hollow sphere, for example, which results in a deflection of gas directed against the baffle plate through 180°.

If this baffle plate is in the form of a deflecting device from both directions, based on the main axis, it is possible firstly to deflect switching gas on one side of the baffle plate and to direct a cooling medium against the baffle plate on the other side and to deflect this cooling medium likewise on the baffle plate in order to introduce this cooling medium into the exhaust channel via the cooling media blow-out opening. It is thus firstly possible to cool the baffle plate and therefore also to indirectly cool the switching gas located on the other side. Secondly, the cooling medium can be directed in a compact manner via the baffle plate and the cooling medium can expand and be distributed over a large area in order to be directed to a cooling media blow-in opening with a large cross section, for example. In order to direct the cooling medium, the baffle plate can have a pot-shaped structure, with the deflecting pots therefore being aligned opposite one another. It is also possible, for example, for a drive element such as a drive rod or the like to pass through the baffle plate in order to make it possible to drive the compression device.

A further advantageous configuration can provide for the switching gas and the cooling medium to be mixed with one another, the cooling medium and the switching gas being directed laminarly into one another.

The cooling medium and the switching gas are mixed within the exhaust channel. By virtue of the switching gas and the cooling medium being conducted laminarly into one another, i.e. flowing into one another in layered fashion, firstly the two fluid flows are caused to be directed into one another with relatively little turbulence. The flow rate in the interior of the exhaust channel is reduced only insubstantially by laminar mixing of the two partial flows. Secondly, owing to the fact that the flows are directed into one another laminarly, in addition a large contact area of the fluid flows with respect to one another is ensured, with the result that effective cooling of the switching gas by means of the cooling medium takes place.

A further advantageous configuration can provide for a flow of the cooling medium to be controlled by a valve.

The use of a valve for charging the cooling media inlet opening is one possibility for applying a certain pressure to the cooling medium in the compression device with and for releasing the cooling medium via the valve only once a limit pressure has been reached. This makes it possible to ensure that the cooling medium flows into the exhaust channel as abruptly as possible via the cooling media blow-in opening and that effective cooling or influencing of the switching gas takes place. In this case, the valve may be, for example, a valve which releases the compressed cooling medium in a manner dependent on the differential pressure. However, provision can also be made for the valve to be removed, with the compressed cooling medium only being released, for example, once a certain switching position of the switching contact pieces with respect to one another has been reached. It is thus possible, irrespective of external influences, for the time at which the compressed cooling medium is blown into the exhaust channel to be controlled depending on the progress of a switching movement.

A further configuration can provide for a cooling medium to be bounded by the encapsulating housing.

Bounding the cooling medium by means of the encapsulating housing makes it possible to use the insulating medium located within the encapsulating housing as cooling medium as well. Furthermore, the possibility is thus provided of allowing switching gas emerging from the outlet opening of the switching vessel and a possibly admixed cooling medium to flow out into the encapsulating housing and to expand there in a large area. Furthermore, a thermal connection to the surrounding environment of the circuit breaker arrangement is provided via the inner wall of the encapsulating housing, with the result that cooling of switching gas/cooling medium once it has emerged from the exhaust channel is now possible.

Within the encapsulating housing, it is now possible for the switching gas to be recombined or cooled or for foreign bodies produced during a switching operation, for example, to be filtered out of the switching gas. For this purpose, corresponding filter devices can be arranged within the encapsulating housing.

The insulating medium located within the encapsulating housing flows through and around the switching vessel and the further component parts of the interrupter unit of the circuit breaker arrangement, with the result that, once an arc has been blown, after a certain amount of time a “regular” insulating medium is completely dispersed in the switching vessel again. This insulating medium is now provided in order to be intermediately stored in the compression device as cooling medium and injected into the exhaust channel, for example, or in order to be converted into switching gas by a burning arc.

A further advantageous configuration can provide for a switching contact piece to protrude into the exhaust channel and to be mounted movably relative to a wall delimiting the exhaust channel.

In order to close or interrupt a current path as quickly as possible, it is advantageous to perform isolation/contact-making of the switching contact pieces at high speed. In particular when driving two switching contact pieces of a switching path in opposite directions, it is possible in a simple manner to achieve an increased contact isolation speed. For improved space utilization, it is possible, for example, to allow a movable switching contact piece to slide into the exhaust channel. An outlet opening of the exhaust channel is located close to the switching path since the exhaust channel also extends around the switching contact piece which can be moved into said exhaust channel. It is thus also possible to allow switching gas emerging from the switching path to pass as directly as possible into the exhaust channel. It is thus possible for an outlet opening to have the configuration of a collecting shroud, for example, in order to direct emerging switching gases from the switching path into the exhaust channel with as few losses as possible.

A further advantageous configuration can provide for the switching contact piece to be driven via the insulating nozzle.

A switching contact piece can be moved via the insulating nozzle. Drive forces are transferred to the switching contact piece via the insulating nozzle for this purpose. In addition, a corresponding gear mechanism can be used. This is particularly advantageous when the compression device is also driven via the insulating nozzle. It is thus possible to couple in a movement on one potential side of the switching vessel and to initiate a movement of the insulating nozzle there and to transfer the movement in electrically insulated fashion also beyond the switching path to the other potential side of the switching vessel, by means of the insulating nozzle. Since the insulating nozzle and the switching contact pieces of the switching path are located within the switching vessel, the transfer mechanism can be arranged within said switching vessel. It is thus possible to fit the switching vessel independently of the encapsulating housing, to adjust the individual assemblies with respect to one another and to insert the switching vessel as a modular unit into the encapsulating housing.

An exemplary embodiment of the invention will be shown schematically in a drawing and described in more detail below.

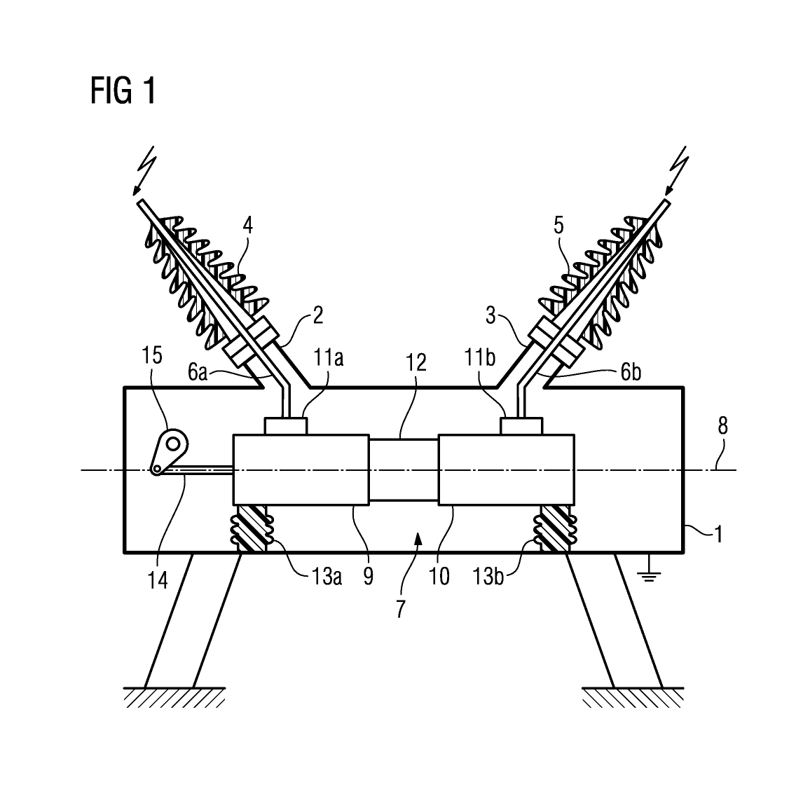

FIG. 1 shows a cross section through a circuit breaker arrangement,

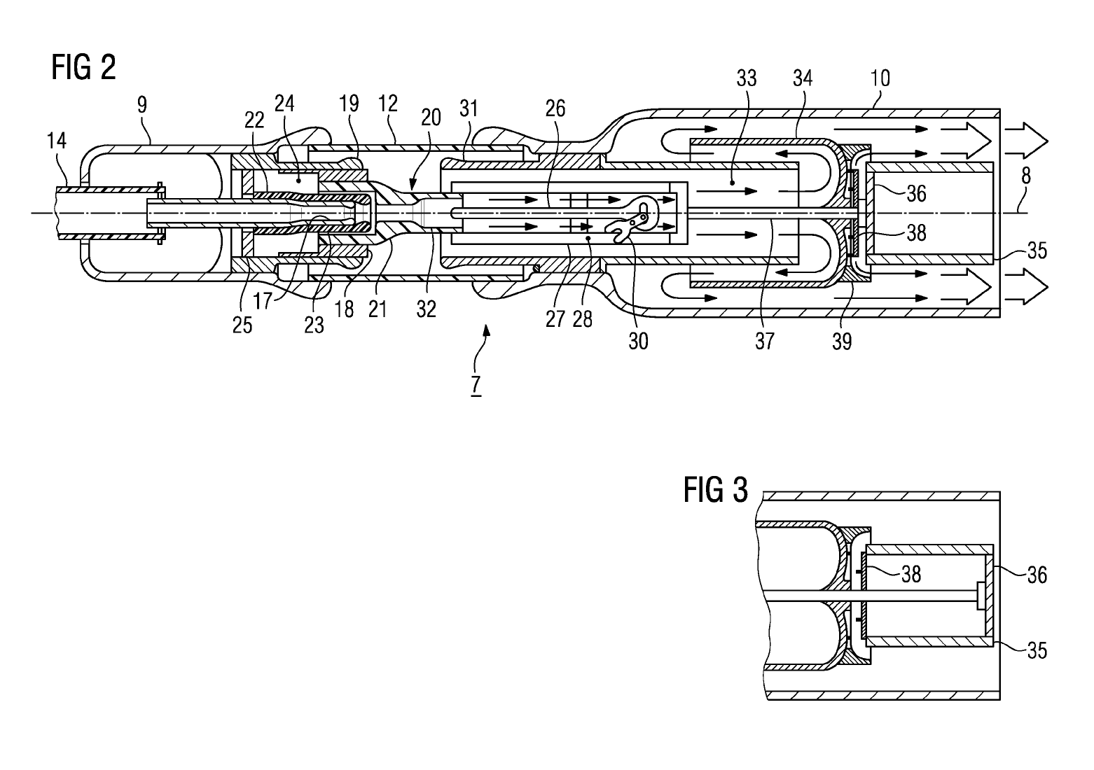

FIG. 2 shows a cross section through an interrupter unit of the circuit breaker arrangement in the break state, and

FIG. 3 shows a detail from FIG. 2 in the make state.

The basic design of a circuit breaker arrangement will first be described with reference to FIG. 1. FIG. 1 shows a circuit breaker arrangement with a so-called dead-tank design, in section. The circuit breaker arrangement has an encapsulating housing 1. The encapsulating housing 1 is in this case substantially rotationally symmetrical and has a substantially circular-cylindrical outer contour. The encapsulating housing 1 is formed from an electrically conductive material and conducts ground potential. Preferably, the encapsulating housing 1 can be in the form of a cast aluminum construction. In this case, the encapsulating housing 1 can be formed in more than one piece, with it being necessary to take care that there is a fluid-tight bond between the individual pieces. Furthermore, walls of the encapsulating housing 1 should likewise have a fluid-tight configuration.

The encapsulating housing 1 is arranged on a mounting rack spaced apart from the respective floor. On the side remote from the floor, the encapsulating housing has a first connecting piece 2 and a second connecting piece 3. The axes of the two connecting pieces 2, 3 are in this case deflected from a perpendicular and tilted in opposite directions to one another. In each case a first outdoor bushing 4 and a second outdoor bushing 5 are arranged on the connecting pieces 2, 3. The two outdoor bushings 4, 5 are connected with their ground-side end in a fluid-tight manner in each case to the first and to the second connecting pieces 2, 3. The two outdoor bushings 4, 5 are used for passing feed lines 6a, 6b in a fluid-tight manner through a wall of the encapsulating housing 1 in electrically insulated fashion. For this purpose, the outdoor bushings 4, 5 each have an electrically insulating basic body, which is provided with ribbing on its outer side, with the result that the outdoor bushings 4, 5 are suitable for use outdoors. The feed lines 6a, 6b are passed outwards in a fluid-tight manner through the respective insulating basic body at the free ends of the basic bodies. It is now possible to connect an electrical line, for example an overhead line, to the free ends of the feed lines 6a, 6b, which are outside the encapsulating housing 1, and to loop the circuit breaker arrangement into a current path to be switched.

An interrupter unit 7 is arranged in the interior of the encapsulating housing. The interrupter unit 7 is aligned substantially coaxially to a main axis 8. The main axis 8 is in this case identical to an axis of rotation of the encapsulating housing 1. The interrupter unit 7 has a substantially rotationally symmetrical contour, with the axis of rotation of the interrupter unit 7 coinciding with the main axis 8. As a result, the interrupter unit 7 and the encapsulating housing 1 are arranged substantially coaxially with respect to one another.

In order to delimit the outer contour of the interrupter unit 7, a closed switching vessel is provided. The closed switching vessel has a first end-side sleeve 9 and a second end-side sleeve 10. The two end-side sleeves 9, 10 are formed from an electrical conductor material. On the lateral surface side, in each case one contact-making element 11a, 11b is arranged on the two end-side sleeves 9, 10. The feed lines 6a, 6b are each electrically conductively connected to the first or to the second end-side sleeve 9, 10 via the contact-making elements 11a, 11b. In addition to making electrical contact with the feed lines 6a, 6b via the contact-making elements 11a, 11b at the two end-side sleeves 9, 10, said contact-making elements can also be used for mechanically holding and positioning the feed lines 6a, 6b. Those ends of the end-side sleeves 9, 10 which are remote from one another can be open in the form of a tube, or else can be partially or completely closed. Depending on requirements, different design variants can be selected. It is advantageous here if a dielectrically favorable terminating configuration of the switching vessel is provided.

In addition to the two end-side sleeves 9, 10, the switching vessel has an insulating link 12 in the form of a closed peripheral tube. This tube can be, for example, a glass-fiber-reinforced plastic body. The two end-side sleeves 9, 10 are positioned relative to one another and connected mechanically to one another at a rigid angle via the insulating link 12, with the result that a closed switching vessel is provided. Alternatively, the insulating link 12 can also be in the form of insulating bars arranged in the form of a cage or other insulating elements. By virtue of the use of a closed switching vessel, the interior of the interrupter unit 7 is delimited by the switching vessel itself and is also largely protected against mechanical influences even in the dismantled state. Furthermore, the interrupter unit 7 can be prefitted and, in the prefitted state, can be inserted into the encapsulating housing 1. The interrupter unit 7 is mounted in the interior of the encapsulating housing 1 via post insulators 13a, 13b. In this case, a lateral-surface-side support of the interrupter unit 7 is provided. However it is also possible for alternative configurations of post insulators to be provided.

The first end-side sleeve 9 has a cutout at the front end side, with a switching rod 14 protruding into the interior of the switching vessel through said cutout. The switching rod 14 is movable along the main axis 8. By virtue of a movement of the switching rod 14, a movement can be coupled into the interior of the switching vessel of the interrupter unit 7, with the result that, for example, a switching operation of the interrupter unit 7 of the circuit breaker arrangement can be performed. A rotatable shaft 15 passes through a wall of the encapsulating housing 1. In the interior of the encapsulating housing 1, a lever arm 16 is fitted on the shaft 15 and converts a rotary movement of the shaft 15 into a linear movement of the switching rod 14. The shaft 15 is guided outwards through the wall of the encapsulating housing 1 in rotationally movable and fluid-tight fashion. The arrangement of a drive device (not illustrated in FIG. 1) on the outer side of the encapsulating housing 1 is now possible, said drive device serving to output a movement for switching rod 14 via the shaft 15.

The encapsulating housing 1 forms a fluid-tight envelope around the interrupter unit 7. The interior of the encapsulating housing 1 is filled with an electrically insulating medium. This medium flows through the encapsulating housing 1 and flows around and through the internals located in the interior of the encapsulating housing 1. Preferably, the electrically insulating medium is an insulating gas such as sulfur hexafluoride or nitrogen or another suitable insulating gas or insulating gas mixture. In order to increase the dielectric strength, it is advantageous to set the electrically insulating gas under an elevated pressure in comparison with the surrounding environment, with the result that the dielectric strength of the insulating medium is additionally increased. In this case, the encapsulating housing 1 can be designed as a pressure tank.

FIG. 1 represents merely a schematic figure illustrating a circuit breaker arrangement. As regards the detailed configurations, there may be corresponding deviations. In particular as regards the dimensions of individual component parts and the configuration in particular as regards a dielectrically favorable configuration and a pressure-tight configuration, there may be deviations. FIG. 1 serves merely as a basic illustration of a circuit breaker arrangement.

In addition to the variant configuration shown in FIG. 1 of a circuit breaker arrangement in the form of a dead-tank circuit breaker arrangement, i.e. the interrupter unit is surrounded by an electrically conductive encapsulating housing which conducts ground potential, the possibility is also provided of implementing a circuit breaker arrangement in the form of a live-tank design. In this case, the encapsulating housing of the interrupter unit is designed to be electrically insulating and this encapsulating housing is constructed so as to be electrically insulated with respect to a ground potential.

The design of an interrupter unit 7 and the mode of operation thereof will be described below with reference to FIGS. 2 and 3. In this case, the illustrations in FIGS. 2 and 3 merely represent basic schematic figures which can be configured differently when a circuit breaker arrangement is actually constructed.

FIG. 2 shows a more detailed illustration of the interrupter unit 7 known from FIG. 1. FIG. 2 shows a first end-side sleeve 9 and a second end-side sleeve 10, which are connected to one another via an insulating link 12. The variant configuration shown in FIG. 2 also provides a closed switching vessel of the interrupter unit 7, whose end-side sleeves 9, 10 are connected by an insulating link 12 in the form of a tube.

The two end-side sleeves 9, 10 are equipped at their mutually facing ends in each case with a holder, which is used for inserting and holding the insulating link 12. The two end-side sleeves 9, 10 are connected mechanically to one another and are kept electrically insulated from one another via the insulating link 12. In order to achieve a dielectrically favorable form, the mutually facing ends of the end-side sleeves 9, 10 are each provided with bead-like integrally formed portions in order to influence electrical fields in a favorable manner. Both the first end-side sleeve 9 and the second end-side sleeve 10 as well as the insulating link 12 are substantially rotationally symmetrical and are arranged coaxially to the main axis 8. The first end-side sleeve 9 is configured so as to be closed in the form of a pot at its end remote from the insulating link 12, with a central cutout being kept free in order to allow the switching rod 14 to protrude into the interior of the switching vessel of the interrupter unit 7. The switching rod 14 is, for example, a glass-fiber-reinforced construction with a tubular configuration. That end of the second end-side sleeve 10 which is remote from the insulating link 12 is in the form of an open front end side, with the result that a circular opening is formed in that end of the end-side sleeve 10 which is remote from the insulating link 12. However, provision can also be made for the second end-side sleeve 10 to be equipped with a constriction or with a front end side which is at least partially closed. In this case, that region of the second end-side sleeve 10 which is remote from the insulating link 12 is extended radially.

The switching rod 14 is connected to a first switching contact piece 17. The first switching contact piece 17 is in this case in the form of a tube and is movable together with the switching rod 14 along the main axis 8. At its end remote from the switching rod 14, the first switching contact piece 17 is equipped with a socket-shaped contact-making region. The socket-shaped contact-making region is in this case delimited by a large number of contact fingers which are distributed radially around the main axis 8 and are elastically deformable. The first switching contact piece 17 is surrounded by a first nominal current contact piece 18. The first nominal current contact piece 18 has a hollow-cylindrical configuration and is displaceable together with the first switching contact piece 17 along the main axis 8. The first switching contact piece 17 and the first nominal current contact piece 18 are DC-connected to one another and always conduct the same electrical potential. The first nominal current contact piece 18 is guided in a guide sheath 19, which is connected at a rigid angle to the first end-side sleeve 9. The guide sheath 19 is electrically conductively connected both to the first end-side sleeve 9 and to the first nominal current contact piece 18. The guide sheath 19 is furthermore provided with a form which is rounded off in a dielectrically favorable manner in the direction of a switching path 20.

An insulating nozzle 21 is fastened to an inner lateral surface of the first nominal current contact piece 18. The insulating nozzle 21 is movable together with the first nominal current contact piece 18. The first switching contact piece 17 is surrounded by an auxiliary insulating nozzle 22. An annular heating channel 23 is formed between the insulating nozzle 21 and the auxiliary insulating nozzle 22, which partially overlap one another.

The heating channel 23 opens out into a switching gas intermediate storage volume 24, which is located between the first switching contact piece 17 and the guide sheath 19 or the first nominal current contact piece 18. The switching gas intermediate storage volume 24 is used for temporally limited intermediate storage of switching gas during a switching operation. A compression device is connected downstream of the switching gas intermediate storage volume 24. The compression device has a movable piston 25, which is movable together with the first switching contact piece 17. The piston 25 is movable within a compression cylinder formed by the guide sheath 19, with the result that a compression volume is produced.

The insulating nozzle 21 protrudes from the first nominal current contact piece 18 towards a second switching contact piece 26. The second switching contact piece 26 is in the form of a bolt and is movable relative to the second end-side sleeve 10 of the switching vessel along the main axis 8. A drive rod 27 is coupled to the insulating nozzle 21, which is movable together with the first nominal current contact piece 18 and the first switching contact piece 17. A driver bolt 28 is located on the drive rod 27 and is moved parallel to the main axis 8 during a movement of the drive rod 27. The second switching contact piece 26 is mounted movably along the main axis 8 and is connected at its end remote from the switching path 20 to a fork lever 29. The fork lever is connected with its first end to a slot in the second switching contact piece 26. Its other end is configured in the form of a fork, with the result that, during a movement of the drive rod 27, the driver bolt 28 moves into the fork and pivots the fork lever 29 about its pivot bearing 30 and thus causes a movement of the second switching contact piece 26 in the opposite direction to the movement direction of the insulating nozzle 21. During a making operation, the driver bolt 28 moves away from the switching path 20, whereas during a breaking movement the driver bolt 28 is shifted in the direction of the switching path 20.

A second nominal current contact piece 31 is arranged coaxially to the second switching contact piece 26. The second nominal current contact piece 31 is mounted fixed in position with respect to the second end-side sleeve 10 and therefore fixed in position with respect to the switching vessel of the interrupter unit 7. The two switching contact pieces 17, 26 are configured in the form of arcing contact pieces of the interrupter unit 7. The two nominal current contact pieces 18, 31 act as nominal current contact pieces of the interrupter unit 7. During a making operation, first the two switching contact pieces 17, 26 and temporally following this the two nominal current contact pieces 18, 31 are brought into DC contact with one another. During a breaking operation, first the two nominal current contact pieces 18, 31 are isolated and temporally following this the two switching contact pieces 17, 26. This means that during a making operation, the two switching contact pieces 17, 26 lead the two nominal current contact pieces 18, 31, whereas during a breaking operation the two switching contact pieces 17, 26 lag the two nominal current contact pieces 18, 31. This ensures that arcs produced during a switching operation are guided on the switching contact pieces 17, 26 and the nominal current contact pieces 18, 31 are protected from contact erosion.

The insulating nozzle 21 has an insulating nozzle channel 32. The second switching contact piece 26 protrudes into this insulating nozzle channel 32. During a switching operation, the second switching contact piece 26 is moved through the insulating nozzle channel 32. Owing to the profiling, i.e. the different cross-sectional configuration over the extent of the insulating nozzle channel 32, the switching contact piece 26 at least temporarily blocks the insulating nozzle channel 32.

The second nominal current contact piece 31 is also formed as part of an exhaust channel 33, in addition to its current-carrying function. The extent of the exhaust channel 33 is represented in FIG. 2 by the flow profile indicated by arrows. The second nominal current contact piece 31 is substantially tubular and extends substantially coaxially to the main axis 8. The second nominal current contact piece 33 faces a baffle plate 34 with its end remote from the switching path 20. The baffle plate 34 in this case has a pot-shaped structure, with that end of the second nominal current contact piece 31 which is remote from the switching path 20 protruding into a pot-shaped cutout in the baffle plate 34. On the pot base, the baffle plate 34 has a hollow-torroidal inner lateral surface, with the result that a deflection of the direction of the exhaust channel 33 takes place at this point. The further profile of the exhaust channel 33 is defined between the outer lateral surface of the baffle plate 34 and an inner lateral surface of the second end-side sleeve 10, with the result that a further change in direction takes place over the extent of the exhaust channel 33.

A compression device 35 is arranged in the region of the free end of the second end-side sleeve 10. The compression device 35 has a hollow-cylindrical compression cylinder, which is mounted fixed in position with respect to the second end-side sleeve 10. Furthermore, the compression device 35 is provided with a compression piston 36. The compression piston 36 is connected to a further drive rod 37. The further drive rod 37 is in turn connected to the drive rod 27, which is attached to the insulating nozzle 21, with the result that a movement of the insulating nozzle is also transferred to the compression piston 36 via the further drive rod 37. The further drive rod 37 engages through the baffle plate 34. In order to compress a cooling medium, an end-side face of the compression cylinder of the compression device 35 is closed with a spring-loaded wall 38. The spring-loaded wall 38 is displaceable along the main axis 8 counter to the force of a spring when an excess pressure is reached in the interior of the compression device 35, with the result that compressed cooling medium can be blasted out of the compression device 35 against the baffle plate 34. In order to direct the cooling medium flow, the baffle plate 34 has a further pot-shaped configuration 39, which brings about a direction of the cooling medium emerging from the compression device 35. At the edge of the further pot-shaped configuration 39, the cooling media blow-in opening is also located correspondingly, via which the compressed cooling medium can be blown out of the compression device 35 into the exhaust channel 33. In this case, the position of the cooling media blow-out opening is selected such that a laminar inward flow of cooling medium into a flow of switching gas in the interior of the exhaust channel 33 is possible.

In the text which follows, the mode in which the interrupter unit 7 operates during a breaking operation will be described. FIG. 3 shows the position of the compression piston 36 of the compression device 35 in the make state of the two switching contact pieces 17, 26 and the two nominal current contact pieces 18, 31. The spring-loaded wall 38 closes the compression space of the compression device 31. The switching contact pieces 17, 26 and the nominal current contact pieces 18, 31 are in DC contact with one another and are intended to be moved into the position shown in FIG. 2. For this purpose, a drive movement is coupled into the interior of the interrupter unit 7 via the switching rod 14. A joint movement of the first nominal current contact piece 18 and the first switching contact piece 17 from the switching path in the direction of the first end-side sleeve 9 takes place. In this case, the insulating nozzle 21 is likewise moved in this direction. Owing to the action as a deflecting gear mechanism, the fork lever 29 moves the second switching contact piece 26 in the direction of the second end-side sleeve 10. The second nominal current contact piece 31 remains unmoved. First, isolation of the two nominal current contact pieces 18, 31 and temporally following this isolation of the two switching contact pieces 17, 26 takes place. In this case, the second switching contact piece 26 is located in the insulating nozzle channel 32 of the insulating nozzle 21 and blocks a constriction of the insulating nozzle channel 32 temporarily. At this time, however, DC isolation of the two switching contact pieces 17, 26 already takes place, with the result that an arc is possibly struck between the two switching contact pieces 17, 26. The arc expands electrically insulating gas, heats this insulating gas and produces a switching gas. Switching gas is generated in the switching path 20, which is located between the two switching contact pieces 17, 26. This switching gas flows through the heating channel 23 into the switching gas intermediate storage volume 24. Owing to the increasing temperature and the increasing following flow of switching gas, the pressure in the interior of the switching gas intermediate storage volume 24 increases. It is not possible for a flow to emerge from said switching gas intermediate storage volume owing to the insulating nozzle channel 32 being blocked by means of the second switching contact piece 26. At the same time, compression of quenching gas as a result of the piston 25 being carried along in the compression space downstream of the switching gas intermediate storage volume 24 takes place. Given a corresponding excess pressure in the compression space connected downstream of the switching gas intermediate storage volume 24, there is an overflow of quenching gas compressed in this compression space into the switching gas intermediate storage volume 24. For this purpose, corresponding overflow channels which can be controlled in a pressure-dependent manner are arranged in the piston 25.

As the breaking movement continues, the second switching contact piece 26 is moved out of the constriction of the insulating nozzle channel 32 and the insulating nozzle channel 32 is released (see FIG. 2). The switching gas located in the switching gas intermediate storage volume 24 flows via the heating channel 23 into the insulating nozzle 21 and through the insulating nozzle channel 32 at least partially in the direction of the second nominal current contact piece 31. Owing to the fact that the second nominal current contact piece 31 stretches over the outlet opening of the insulating nozzle channel 32 in the form of a hood, the emerging switching gas is guided into the interior of the second nominal current contact piece 31. The second nominal current contact piece 31, as part of the exhaust channel 33, conducts the switching gas in the direction of the baffle plate 34. There, the switching gas is deflected through 180° and blasted against an inner wall of the second end-side sleeve 10 in order to be deflected again in the opposite direction. This results in a meandering profile of the exhaust channel 33 and, over a limited area, a path extension of the exhaust channel 33 can be achieved. In a section of the exhaust channel 33 which is in the form of an annular gap and which is formed between the baffle plate 34 and an inner lateral surface of the second end-side sleeve 10, the switching gas now flows away coaxially to the main axis 8.

During a breaking movement, at the same time as a transfer of the breaking movement via the insulating nozzle 21 onto the drive rod 27, the further drive rod 37 is also carried along and the compression piston 36 is thus moved, as a result of which a cooling medium is compressed in the interior of the compression device 35. The cooling medium is, for example, the electrically insulating gas located in the interior of the encapsulating housing 1. When a limit pressure in the interior of the compression device 35 is exceeded, the spring-loaded wall 38 moves counter to the force of the spring and releases the cooling medium which is intermediately stored in the interior of the compression device 35 and has an elevated pressure. The cooling medium is blasted against the baffle plate 34. In the process, the blasting direction is directed such that the hot switching gas and the cooling medium are blasted from opposite directions against the baffle plate 34. This ensures that the baffle plate 34 heated by the hot switching gas is cooled by the cooling medium flowing out of the compression device 35 and therefore also indirect cooling of the hot switching gases via the cooled baffle plate 34 takes place. Furthermore, the cooling medium flow can be deflected radially outwards via the baffle plate 34, with the result that the coolant is coupled laminarly into the switching gas flow via the cooling media blow-in opening, with the result that large-area contact is made between the switching gas and the cooling medium. The combined flow of switching gas and cooling medium now flows around the compression device radially in layered fashion in the direction of the outlet, arranged at the front end side, of the exhaust channel in the second end-side sleeve 10 and flows from there into an interspace between the interrupter unit 7 and an inner wall of the encapsulating housing 1. The exhaust channel opens out in one front end side of the switching vessel of the interrupter unit 7.

Once it has left the switching vessel, the switching gas as well as the compressed additionally blown-in insulating gas can be recombined within the encapsulating housing 1.

1-15. (canceled)

16. A circuit breaker arrangement, comprising:
a switching path and an exhaust channel communicating with said switching path for exhausting switching gas arising in said switching path; and
a cooling media blow-in opening issuing into said exhaust channel.

17. The circuit breaker arrangement according to claim 16, which comprises a compression device fluidically connected to said cooling media blow-in opening.

18. The circuit breaker arrangement according to claim 16, wherein said switching path is arranged in a switching vessel, and said exhaust channel opens out outside of said switching vessel.

19. The circuit breaker arrangement according to claim 18, which comprises a fluid-tight encapsulating housing surrounding said switching vessel.

20. The circuit breaker arrangement according to claim 16, wherein said compression device delimits said exhaust channel at least partially.

21. The circuit breaker arrangement according to claim 16, which further comprises a switching gas intermediate storage volume, which extends, with respect to a main axis, on a first side of said switching path, and said exhaust channel extends on a second side of said switching path opposite said first side.

22. The circuit breaker arrangement according to claim 16, which comprises an insulating nozzle surrounding said switching path and configured to move relative to a switching contact piece.

23. The circuit breaker arrangement according to claim 22, wherein said compression device is a mechanical compression device that is driven via said insulating nozzle.

24. The circuit breaker arrangement according to claim 21, wherein said compression device is aligned coaxially with said main axis.

25. The circuit breaker arrangement according to claim 16, which comprises a baffle plate arranged over an extent of said exhaust channel and configured for deflecting the switching gas, wherein the switching gas is blasted against said baffle plate, and the cooling medium is likewise blasted against said baffle plate, the switching gas and the cooling medium being blasted against said baffle plate from mutually opposite directions.

26. The circuit breaker arrangement according to claim 16, wherein the switching gas and the cooling medium are mixed with one another, the cooling medium and the switching gas being directed laminarly into one another.

27. The circuit breaker arrangement according to claim 25, which comprises a valve configured to control a flow of the cooling medium.

28. The circuit breaker arrangement according to claim 19, wherein a cooling medium is bounded by said encapsulating housing.

29. The circuit breaker arrangement according to claim 16, which further comprises a switching contact piece protruding into said exhaust channel and movably mounted relative to a wall delimiting said exhaust channel.

30. The circuit breaker arrangement according to claim 29, which comprises an insulating nozzle surrounding said switching path and configured for driving said switching contact piece.
